(19) United States
(12) Patent Application Publication
(10) Pub. No.: US 2012/0031805 A1
(43) Pub. Date: Feb. 9, 2012

(54) Daily Meal Planning System

(76) Inventor: Kathleen K. Stolarczyk, San Francisco, CA (US)

(21) Appl. No.: 13/206,268

(22) Filed: Aug. 9, 2011

Related U.S. Application Data
(60) Provisional application No. 61/372,063, filed on Aug. 9, 2010.

(51) Int. Cl. A45C 11/20; A47J 43/28; B65D 85/00

(52) U.S. Cl. 206/541; 206/459.5; 30/324

(57) ABSTRACT

A daily meal planning system may include plates, cups, bowls, measuring scoops, lunch boxes, trays, mats, and other eating utensils that are sized in proportion to the nutritional needs of a user, based upon a user's age, height, and/or weight. Additionally the daily meal planning system may include a plurality of food wells or segregated areas, each food well or segregated area may include an indicium that indicates a color of food to be placed in the given food well or segregated area. By varying the colors of food within a food group throughout the day, the daily meal planning system ensures that a user receives at least a recommended amount of nutrition for the user's age, height, and/or weight.

### REFERENCE TO RELATED APPLICATIONS

This application claims benefit of the filing date of U.S. Provisional Patent Application No. 61/372,063. U.S. Provisional Patent Application No. 61/372,063 is hereby incorporated by reference herein.

### FIELD OF THE INVENTION

The present disclosure is generally related to a daily meal planning system. The present disclosure is more specifically related to daily meal planning devices for a user that provide a nutritionally sufficient daily meal plan.

### BACKGROUND

Feeding devices, such as plates, cups, bowls, lunch boxes, trays, mats, and other eating utensils, are typically used to support or deliver food during meals to a user. Most feeding devices are simply structures that are capable of holding or supporting food for a given meal. Some plates exist that have multiple sections, cordoned off by raised partitions. However, these cordoned off sections simply divide the plate into different zones so a user can keep certain foods separated. Efforts have been made to produce plates including some nutritional guidance such as identifying food groups or portion sizes. Additionally, some storage containers exist that are sized to certain measurements (e.g., one quart, one pint, 100 ml, etc). However, no existing feeding devices suggest meal plans that provide a full day's worth of recommended food-based vitamins and other nutrients based on a user's age, height and/or weight.

Similarly, various types of drinking vessels for children are known. While some drinking vessels exist that include lids and drinking tubes to prevent spills from toddlers, these drinking vessels do not provide a meal planning component based on nutritional guidance of any sort. Some of these drinking vessels are commonly known as “sippy cups.”

At present, the unit of measure adopted in determining the amounts (e.g., volumes) for children of foods, such as meats, fruits, vegetables, whole grains and the like, is the “spoon,” and perhaps where greater accuracy is applied the “measuring cup” or “measuring spoon.” Thus, when predetermining the amount of food to be given a child, the current practice is to utilize a typical “spoon,” which may vary greatly in size from spoon to spoon, or a standard “measuring cup” or “measuring spoon,” when measuring serving or portion sizes for children.

The commonly adopted resource in the United States for determining types and varieties of healthy foods for children, such as meats, fruits, vegetables, grains and the like, is the “USDA dietary guidelines,” except where these guidelines do not apply, as in the instance of children under the age of two. Here the use of Dietary Reference Intakes (DRIs), along with the latest infant and toddler nutrition research and guidelines for children under the age of two from the American Heart Association and American Academy of Pediatricians, are helpful.

As of today these guidelines and units of measure are entirely arbitrary since they vary within wide limits according to the parent or caregiver's choosing. For instance, caregivers may or may not seek out guidance regarding proper amounts, types and varieties of foods when feeding children. And for those aware of standard dietary guidelines many still may rely on “what is readily available” and “rule of thumb” estimates when determining portion size and types and varieties of foods when feeding children.

Under such variable conditions a great difference may exist between the dietary standards adopted by nutrition experts and the actual diet determined largely by the child's parents or caregivers in planning and carrying out feedings. For example, healthy child nutrition guidelines may call for ½ cup of vegetables per day, and the child's parent or caregiver may or may not know the dietary guidelines for vegetables nor make use of a standard device such as “measuring cup” to determine the amount. Even if he or she would utilize the proper “measuring cup,” one cannot be sure he or she would know to vary the types and varieties of foods to ensure recommended consumption of daily recommended food-based vitamins and nutrients.

Harm may come to children as a result of poor meal planning, due to differences in dietary standards as well as such differences in “spoons” or “measuring cups.” Most children lack the ability to plan or prepare meals and thus, require the help of a parent or caregiver in determining the variety and amount of food given to prepare. If the amount of food the child's parent or caregiver serves is of only one ‘favorite’ type or category of food or of a larger or smaller capacity than the recognized dietary guidelines suggest, the child will be either underfed or overfed. If the types or variety of food the child's parent or caregiver serves them differs greatly from the recommended guidelines, the child may in fact become improperly nourished, resulting in health and growth impairment with a higher susceptibility to childhood diseases or disorders.

The World Health Organization attributes malnutrition, in all forms, as a major contributor to disease and early deaths for mothers and children globally. Under nutrition, including vitamin and mineral deficiencies, contributes to about one third of all child deaths, and impairs healthy development and life-long productivity. At the same time, growing rates of overweight are linked to a rise in chronic diseases. The result is what researchers refer to as “a double burden of malnutrition.”

100111 The Center for Disease Control recently reported one-in-five children are overweight or obese by the age of 6; research studies have proven children who are overweight or obese between the ages of 5 and 7 are likely to remain so for life. Childhood obesity has become the most chronic health condition of childhood. According to the American Medical Association, as American children eat poorly and exercise less, rates of chronic illness such as asthma and diabetes are continuing to rise. In 2004, more than 7 percent of U.S. children and youth were hampered in their daily activities by an illness that lasted three months or longer, compared to just 1.8 percent of children in 1960. Chronic conditions now affect 15 percent to 18 percent of children and teens, and even those estimates may not fully account for obesity and mental health woes. The “big three” chronic health conditions for kids are obesity, which affected only 5 percent of American children in the early 1970's but 18 percent of children today; asthma which has a 9 percent prevalence, nearly double from the 1980's; and attention deficit hyperactivity disorder which has seen a dramatic rise, mostly linked to better diagnosis. Because childhood illness often sets the stage for adult health woes, the U.S. health-care system could be headed toward a crisis in the coming decades

Additionally, research indicates taste buds and healthy eating behavior can be trained in young children. Repeated exposure to vegetables, in infants of 4 to 6 months, results in all infants increasing their intake after repeated exposure. Ages 6 to 12 months form in a sensitive period for the introduction of solid textures, as the tongue learns to move solid food around mouth in preparation for swallow. Early exposure predicts consumption of fruit and vegetables at seven years. Weaning practices will therefore contribute to later childhood diet—and possibly to childhood obesity. Toddlers, ages 12-18 months, become increasingly reluctant to try new foods during the second year of life—what researchers refer to as the “neophobic phase”. This coincides with the child's developing “sense of order” and need for repetition and structure. During this process, toddlers become more aware of the local details of food, and refuse to eat food that doesn't look “right.” Foods are identified as “known” or “unknown” and new foods and some previously accepted foods will be rejected on sight. Children of this age are also able to form sophisticated categories: foods (e.g., raisins) and non-foods (e.g., animal feces); foods they like and foods they don't like; things that are disgusting and things that are okay, etc. At some point between 18-24 months, most children move out of the “neophobic phase” because of: imitation of other's behaviors; development and comprehension of food categories; less emphasis on local features of foods; and repetitive exposure to new foods. Children imitate other adults—and their parents' eating behavior, and will try new foods that they see their parents eat. Children of nursery school age will imitate the eating habits and food preferences of other children. Introducing a particular food up to 14-20 times ensures the child has enough opportunities to form a food preference. By preparing and serving a wide variety of nutritious foods in recommended volumes, as well as encouraging the child to taste and engage in messy play, parents can train their child's taste buds, as well as establish his/her healthy eating habits for life. Thus, with the proper tools, every mealtime becomes an opportunity to raise a healthy, independent eater.

Accordingly, a need exists to do away with the above mentioned inconveniences and support the proper care and feeding of children. Proper feeding of children results in an increase in recommended levels and varieties of consumption of protein, fruits, whole grains and vegetables, which exposes children daily to essential food-based vitamins and nutrients. This increased exposure will improve vitality and overall long-term health of children and adults.

### SUMMARY

A daily meal planning system may include meal planning devices, such as plates, cups, bowls, measuring scoops, lunch boxes, trays, mats, and other eating utensils. Serving sizes suggested by the meal planning devices may be sized in proportion to the nutritional needs of a child, based upon a child's age, height, and/or weight. In one embodiment, a meal mapping kit may include a plurality of meal planning devices, for example, a plurality of plates and a plurality of measuring scoops that are sized based upon nutritional needs of children of certain ages (e.g., ages 6-12 months, 12-36 months, 3-5 years, etc.). By selecting age appropriate meal planning devices, a parent can create a full day's worth of nutritionally balanced and properly portioned meals for a child based solely on the child's age, height, and/or weight and corresponding nutrition requirements.

In another embodiment, a set of meal planning devices may include a plurality of meal plates and/or snack plates each including compartments or segregated areas (such as wells formed on the surface of the plate or designated areas on the surface of the plate) that map and measure recommended levels and types of food for consumption at a given meal, based on a child's age, height, and/or weight. Each segregated area or food well may be sized to correspond to measurements based on nutrition research, including information found in dietary guidelines established by the World Health Organization, the United States Department of Agriculture, the American Academy of Pediatrics, and/or the American Heart Association. A volume of each food well corresponds to the recommended amount of food per sitting based upon a child's age, height and/or weight. Each food well may be labeled (with words, pictures, and/or colors) with one of six categories of food, as recommended for healthy children. In other embodiments, more or less than six food categories may be used. Surrounding each well is a color coded rim, at least one color coded rim corresponding to a color of food within the food category identified in the food well. A volume of each food well (or a volume of food that fits in the segregated area) and the plate in which the food wells are formed, create properly proportioned sections based on a child's age, height, and/or weight and corresponding nutrition requirements. The food wells (or segregated areas) may be circular in shape, and may be set within, or on top of, the solid core of the plate. These food wells (and segregated areas) may take any other shape, as long as the food well (or segregated area) continues to correspond to the recommended volume of a particular food group, based upon a child's age, height, and/or weight, when the food well (or segregated area) is filled with food.

Additionally, each food well (or segregated area) may provide meal planning and nutrition guidance by including indicia or colors that indicate food groups and varieties of foods within each food group. The indicia or colors may vary from plate to plate, depending upon which meal the plate is intended to be used.

In yet another embodiment, an interlocking set of measuring scoops are sized to correspond with recommended food categories (e.g., fats/oils, dairy, protein, whole grains, fruits and vegetables) and to correspond to recommended nutritional measurements for a given food category and the child's age, height, and/or weight. When used together, the interlocking set of measuring scoops form a device for preparing a well-balanced meal that meets recommended level of consumption guidelines for a given child's age, height and/or weight, as determined by nutritional guidance.

In yet another embodiment, each measuring scoop in the set of measuring scoops comprises a measuring well at one end, the well corresponding to a recommended food group and a corresponding serving size based on a child's age range (e.g., 12-24 months, 24-36 months, 3-5 years, etc.), height, and/or weight. Each scoop may include at least one indicium, and/or color, that corresponds to a food category associated with an individual scoop. When used together, the set of scoops facilitate preparation of a nutritionally balanced meal for a child within the particular age, height, and/or weight range of the set. For example, a 12-24 month old will have a set based on recommended serving sizes for that age, a 24-36 month old will have a different set that measures slightly bigger portions based on higher daily caloric/nutritional requirements, and 3-5 year old will be bigger yet, based on further increased caloric/nutritional needs.

In yet another embodiment, a set of measuring spoons is interlocked at one end of each measuring spoon. A measuring well of a smallest spoon in the set of measuring spoons may fit into the measuring well of the next larger sized spoon, forming a nested configuration when the spoons are stacked upon one another. The spoon set may be interlocked with a ring or pin through a hole in a handle of each spoon.

In yet another embodiment, a portioned drinking cup with interchangeable lids may include serving-size guidance. While young children begin to drink independently using spouted cups, a parent or caregiver may appreciate guidance depicting a recommended proportion or serving of a beverage to feed the child. For example, the milk cup indicates 4 oz. line, which when filled is approximately equal to one child size serving of dairy; the juice cup indicates a 4 oz. line and a 4 oz. water line, which when filled to the 4 oz. line with fruit or vegetable juice is approximately equal to one child size serving of a fruit or vegetable and when water is added to the 4 oz line is capable of diluting the juice to a 50/50 beverage; the water cup indicates a 8 oz line, which is approximately equal to one serving of water.

In yet another embodiment, the drinking cup may include a plurality of differently styled tops. While children may have similar requirements on what, when and how much they drink, sometimes a child's unique disposition or physical ability points to a certain style of the physical task of drinking. Thus, the interchangeable lids allow a parent to find the best drinking style for their child. The adjustable lids allow the parent to not have to purchase a new cup once the child has graduated past the applicable lid, thereby preserving the measurement values on the cup itself and simply changing the lid to correspond to the child's sipping ability and/or preference.

In yet another embodiment, a plurality of differently sized drinking cups may be formed to use a commonly sized lid so that the same lid may be used on larger cups as the child grows.

### BRIEF DESCRIPTION OF THE DRAWINGS

The foregoing aspects and many of the attendant advantages of this disclosure will become more readily appreciated as the same become better understood by reference to the following detailed description, when taken in conjunction with the accompanying drawings, wherein:

FIG. 1 is a perspective view of a set of meal plates constructed in accordance with the teachings of the disclosure;

FIG. 2 is atop view of a breakfast plate from the set of meal plates of FIG. 1;

FIG. 3 is a top view of a lunch plate from the set of meal plates of FIG. 1;

FIG. 4 is a top view of a dinner plate from the set of meal plates of FIG. 1;

FIGS. 5A-5E illustrate perspective views of a plurality of measuring scoops that form a set of measuring scoops constructed in accordance with the teachings of the disclosure;

FIG. 5F is a perspective view of the plurality of measuring scoops of FIGS. 5A-5E in a nested configuration;

FIGS. 6A-6C illustrate perspective views of a plurality of drinking cups that may form a set of drinking cups constructed in accordance with the teachings of the disclosure;

FIGS. 7A-7C illustrate perspective views of a plurality of drinking cup lids constructed in accordance with the teachings of the disclosure;

FIG. 8 is a perspective view of a 3-in-1 eating utensil constructed in accordance with the teachings of the disclosure;

FIG. 9 is a perspective view of a variable-portion dicer constructed in accordance with the teachings of the disclosure;

FIG. 10 is a perspective view of a daily meal planning kit including a plurality of meal plates, a plurality of drinking cups, and a plurality of eating utensils;

FIG. 11 is a perspective view of another alternative of a meal plate constructed in accordance with the disclosure; and

FIG. 12 is a top plan view of the meal plate of FIG. 11, including two interchangeable food group cards.

### DETAILED DESCRIPTION

Although the present disclosure will be described with regard to illustrative examples and embodiments, one skilled in the art will appreciate that the disclosed embodiments and examples should not be construed as limiting. The various embodiments may be practiced in combination or individually. Accordingly, the disclosed and described embodiments should not be construed as requiring any particular combination or excluding any combination unless specifically identified in the disclosure.

The embodiments described below with reference to the figures are useable by a child and enable any caregiver or practitioner, whether a specialist or not, to provide the recommended variety and levels of consumption, according to children's dietary guidelines, with little error in measurement. Thus, the child will thrive by being fed in the appropriate types of food in proportion to increases in age, height, and/or weight—free from variations or disturbances in nutritional requirements. Consequentially the embodiments described below assist in reducing children's disease and death rates related to improper nutrition, either by way of under- or over-feeding.

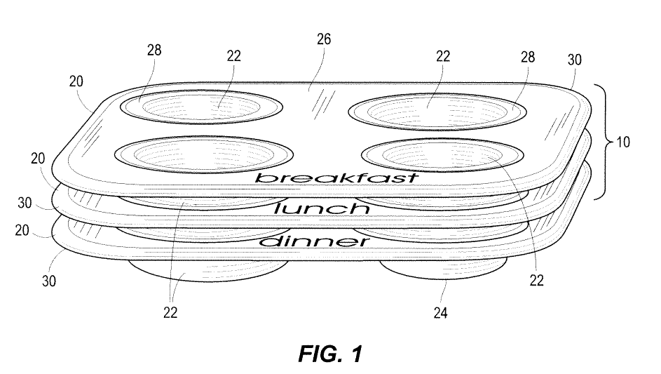

As illustrated in FIG. 1, a set of meal planning devices 10 may include a plurality of meal plates 20, each meal plate 20 having properly proportioned food wells 22 that when used together ensure recommended daily consumption levels of various food groups for a child of a given age, height, and/or weight. Alternatively, a top surface 26 of the meal plate may be segregated by lines or other indications, the segregated areas being properly proportioned for a child of a given age, height, and/or weight. The food wells 22 (or segregated areas) are properly proportioned in size, food groups, and varieties of foods within food groups and the proper use of the food wells 22 (or segregated areas) ensures adequate nutrition for each meal and proper overall daily nutrition.

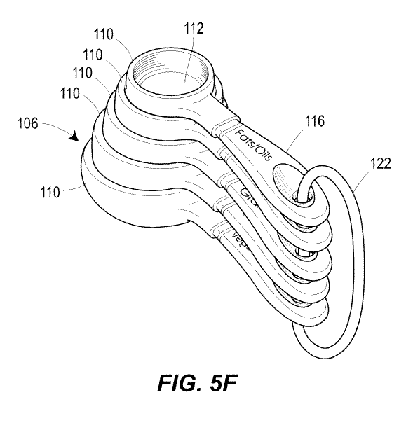

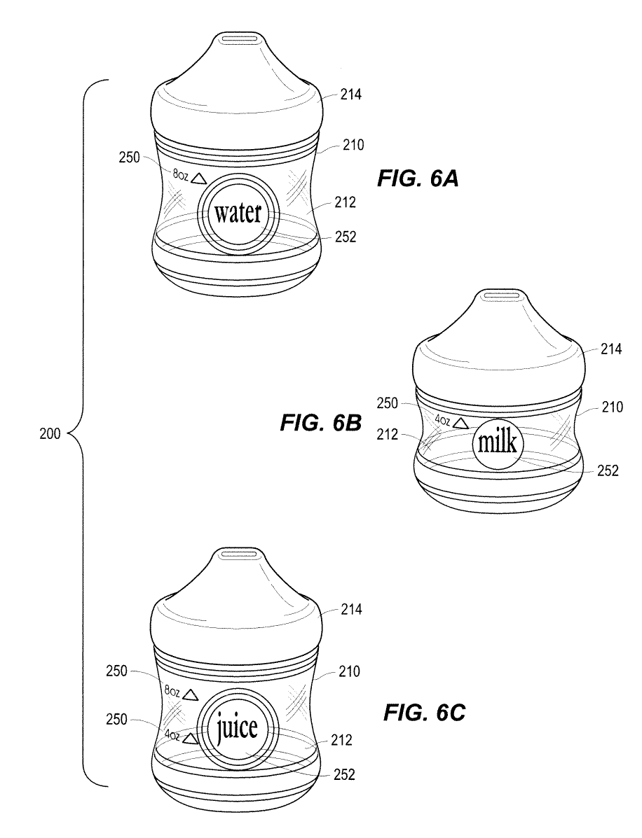

In one embodiment, each meal plate 20 may be square or rectangular-shaped (or any other shape) including a rubberized base 24 adapted for resting on the surface of a table. Each meal plate 20 also may include the top surface 26 and four food wells 22 formed below the top surface 26. In an alternative embodiment, instead of food wells 22, the top surface 26 of the meal plate 20 may be segregated into proportionally sized areas. The means of segregation may include, for example, walls, dimples, trenches, or any other surface feature, as well as lines or other markings that separate one area from another. Each well 22 may have a similar depth to allow the plate to rest on the surface in a stable and balanced orientation. Alternatively, if the food wells 22 have varying depths, a spacer (not shown) may be added to the bottom of one or more food wells 22 to stabilize the meal plate 20 when resting on the surface. Each food well 22 may have a volume that corresponds to a recommended amount of a given food group. In some embodiments, one or more food wells 22 (or segregated areas) may have identical circumference, area, or volume if identical areas or volumes correspond to different food groups for a given meal. However, at least two of the food wells 22 (or segregated areas) will have different volumes (or areas) on any given meal plate. In one embodiment, the fruit and vegetable food wells 22 (or segregated areas) define approximately one half of the total food volume for a meal, while the protein and grain food wells 22 (or segregated areas) define approximately one quarter each of the total food volume for a meal. A parent or other adult may add dairy in addition to the food groups illustrated in the food wells 22 (or segregated areas) by including, for example, milk in a proportional cup, as illustrated further below in FIGS. 6 and 7.

Returning now to FIG. 1, each meal plate 20 may include a raised wall 28 surrounding each food well 22. The raised wall 28 keeps food within the food well 22 and prevents food from sliding out of the food well 22 when food is placed within a given food well 22. The volume of the food well 22 that corresponds to a recommended volume for a particular food group is measured from a bottom of the food well 22 to a level that is approximately equal to the top surface 26 of the meal plate 20. One skilled in the art will appreciate other shapes, such as a triangle or square, may be utilized as long as food well function is not impacted. Additionally, if segregated areas are used instead of food wells 22, the segregated areas need not have raised walls surrounding the segregated areas as long as the segregated areas maintain recommended proportions based upon the child's age, height, and/or weight.

Additionally, each meal plate 20 may include a perimeter wall 30 that extends above the top surface 26. The perimeter wall 30 may extend to a height that is equal to, or greater than, a height of the raised wall 28. When stacked, a bottom surface of one meal plate 20 rests upon the perimeter wall 30 of another meal plate 20 in a nested configuration for ease of transportation or storage. The nested configuration is stable due to the nesting of the food wells 22 and the perimeter wall 30.

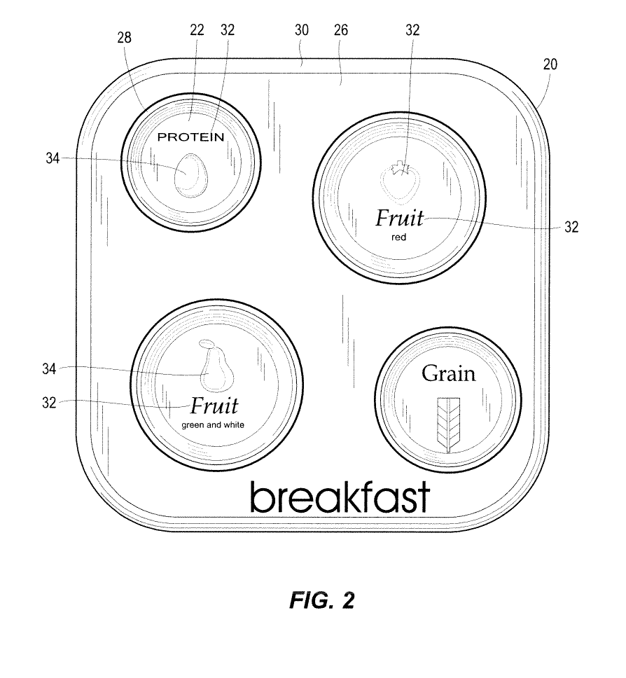

As illustrated in FIGS. 2-4, in one embodiment three meal plates 20 may comprise one daily set. Each food well 22 may include indicia 32 and/or pictures 34 that indicate the particular food group that is to be placed in a particular food well. For example, the food well 22 in the upper right corner of the breakfast plate in FIG. 2 may include indicia 32 indicating that this particular food well 22 is for fruit. Additionally, the same food well 22 may include a picture of a strawberry 34 indicating that a red and/or pink colored fruit should be placed in this particular food well 22. Similarly, indicia 32 and pictures 34 may be located in other food wells 22 to indicate the food group and color of food to be placed in a particular food well 22. In the same upper right location of the meal plate 20, the lunch meal plate 20 fruit food well 22 may include a picture 34 that illustrates blue and/or purple fruit such as a plum and/or blueberries. In the same upper right location of the meal plate 20, the dinner meal plate 20 fruit food well 22 may include a picture that illustrates orange and/or yellow fruit such as a peach and/or mango. When used collectively, all three meal plates, breakfast, lunch and dinner, and their twelve total corresponding food wells 22, measure and feed the child a day's worth of properly balanced, nutrient rich meals. Any single plate used individually provides a well-balanced meal meeting a recommended level of consumption guidelines for one child-size meal. This fruit and vegetable variation feature is referred to as “meal mapping.” Fruit and vegetable variation may be suggested by characteristics other than color. For example, fruit variation may be suggested throughout the day by varying the family of fruit that is served (e.g., berries, melons, citrus, etc.). Similarly, vegetable variation may be suggested throughout the day by varying the family of vegetable served (e.g., squash, legumes, leafy greens, etc.).

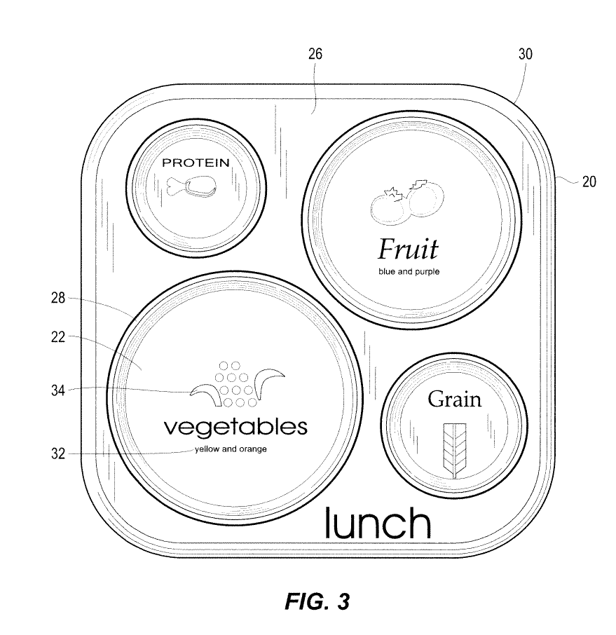

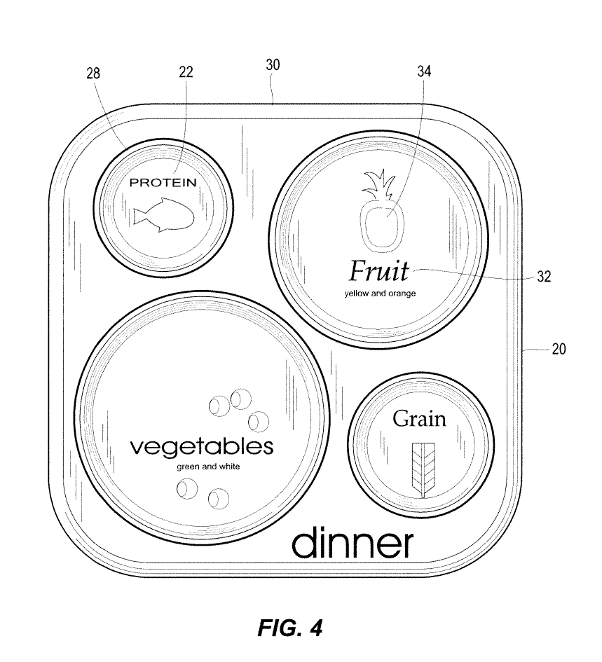

While the food wells 22 include indicia 32 and pictures 34 representing the food group to be placed in an individual food well 22, a variety of foods within each food group is also necessary to ensure a child receives well balanced nutrition throughout the day. Variety is particularly important when considering fruits and vegetables. One way to ensure a variety of fruits and vegetables are provided throughout the day is to vary the colors of the particular fruits and vegetables served to the child. To facilitate variety, especially the amount of fruit and vegetable groups, different colors of fruits and vegetables are specified for different meals. For example, one meal plate 20 (FIG. 2) illustrates a red and/or pink fruit in one food well 22, while another meal plate 20 (FIG. 3) illustrates a blue and/or purple fruit in the same food well 22, and yet another meal plate 20 (FIG. 4) illustrates a yellow and/or orange fruit in the same food well 22. To further identify the color of food placed in an individual food well 22, the raised wall 28 surrounding a particular food well 22 may have the same color as the color of food specified for that particular food well. For example, the raised wall 28 surrounding the fruit food well 22 in the upper right corner of the one meal plate illustrated in FIG. 2, may be colored red and/or pink to match the red and/or pink fruit picture 34 in the food well 22. This color coordination and coding produces a food meal mapping (or matching) system that is easy to use and understand. By following the foot types, color coding and portion sizes identified in the food wells 22, a parent or other adult can be assured a child is receiving a healthy, well balanced set of meals throughout the day.

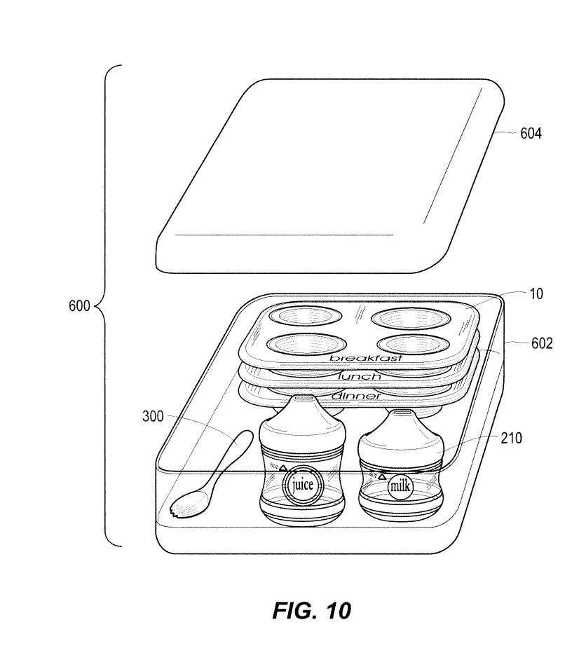

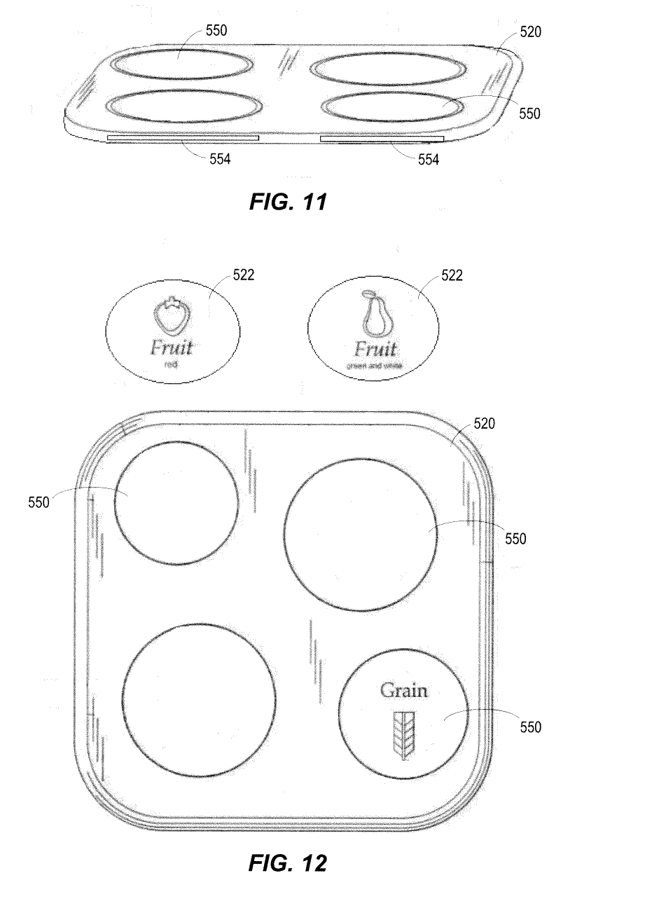

In an alternative embodiment, a single meal plate 520 could include a plurality of interchangeable food wells or segregated areas, as illustrated in FIGS. 11 and 12. The plate 520 is then customizable for an individual meal while retaining the meal mapping feature. The plate 520 may include one or more see-through windows 550. A food group card 552 (or cartridge) may be inserted into a slot 554 in the plate 520. The food group card 552 may have indicia printed thereon, for example, one of a textual representation, a picture, and/or, a color, that represent a particular food group or category, as well as a color or suggested variety of the food indicated. When inserted into the slot 554, the indicia printed on the food group card 552 are visible through the window 550, as illustrated in the bottom right window 550 of FIG. 12. A plurality of interchangeable food group cards 552 may be used to impart the meal-mapping functionality described above. Alternatively, a set of meal cards that represent more than one food group may be used.

Various components of the meal plate may be formed of similar or different materials. For example, in one embodiment, the various components may be formed from a PLA corn-based resin, but the meal plate could also be constructed of child-safe copolyester, such as EASTMAN TRITAN EX401, stainless steel or other child-safe alternative.

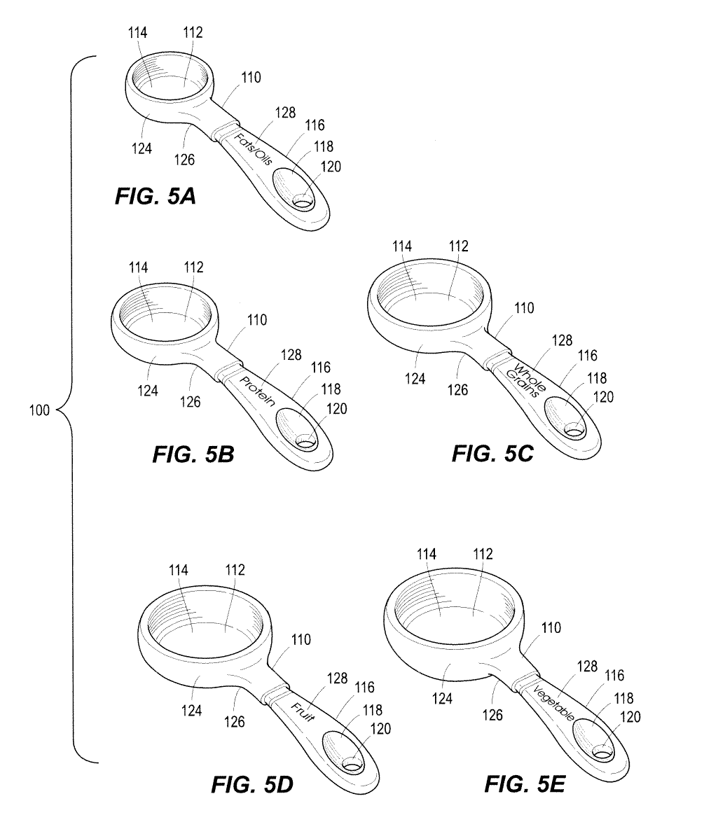

Turning now to FIGS. 5A-5E, a set 100 of measuring scoops 110 is illustrated. The measuring scoops 110 are sized to correspond to recommended serving sizes of particular food groups or categories based on a child's age, height, and/or weight. In the embodiment illustrated in FIGS. 5A-5E, five measuring scoops 110 may comprise a set 100 of measuring scoops. In other embodiments, more or less than five measuring scoops 110 may comprise a set 100. Each measuring scoop has a pre-measured well 112, which may be made of a relatively thin portion having a concave surface 114. However, the wells 112 are formed to correspond to a particular food category and a corresponding serving size based on the age of a child. When used together, the measuring scoops 110 measure one balanced meal for a child within the particular age range of the set. For example, a 12-24 month old will have a set 100 based on recommended serving sizes for that age, a 24-36 month old will have a different set 100 that measures slightly bigger portions based on higher daily caloric and nutritional requirements, and a 3-5 year old set 110 will be bigger yet, based on increased caloric and nutritional needs. One skilled in the art will appreciate that other shapes in place of circular wells 112, such as squares or triangles, or any shape that is suitable for holding and measuring food, may be used.

Each measuring scoop 110 also may include a handle portion 116, the handle portion being connected to the well 112. A recessed area 118 may form a thumb or finger hold on the handle portion 116, and an opening 120 may be formed in the recessed area 118. The opening may be sized to receive a clasp 122 (FIG. 5F) that secures each measuring scoop 110 in the set 100 to one another for storage. The wells 112 of the measuring scoops 110 are sized to fit within one another in a nested configuration as illustrated in FIG. 5F.

The wells 112 are pre-measured and increase in size according to the recommended serving size for each food category identified on the measuring scoop 110. As a result, a volume of food for a particular food group is measured that is suitable for serving to children based on their age, height, and/or weight. Each well 112 extends from a body 124 defining a rubberized base portion 126 that is connected to the handle portion 116. Each handle portion 116 may include indicia 128 or a representative picture (now shown) identifying a food category of food group that corresponds to the indicated serving-size volume of well 112.

As best seen in FIG. 5F when assembled there is an interlocking nesting nature of the measuring scoops 110. The well 112 of the smallest measuring scoop 110 fits into the well 112 of the next larger sized measuring scoop 110. When stacked together, the set 100 of measuring scoops 110 is interlocked together by the clasp or ring 122. One skilled in the art will appreciate the measuring scoops 110 may be secured to one another with other securing devices, such as pins, hook-and-loop fasteners, magnets, etc. Various components of the measuring scoops 110 may be formed of different or similar materials. For example, in one embodiment, the various components may be framed from PLA corn-based resin, but the measuring scoops 110 could also be formed from child-safe copolyester, such as EASTMAN TRITAN EX401, stainless steel, or other child-safe alternative.

Referring to FIGS. 6A-6C, a set 200 of portion drinking cups 210 are illustrated. The portion drinking cup 210 includes a reservoir 212 for holding liquid for serving to a child. The reservoir 212 is preferably substantially cylindrical in shape, but may be of any shape that is adaptable for use as a reservoir for holding liquid for consumption. For the purposes of describing an exemplary embodiment of the reservoir, the reservoir is illustrated to be cylindrical. Thus, in this embodiment, the reservoir and a corresponding lid 214 are substantially cylindrical and/or circular. The portion cup 210 may include one or more interchangeable lids 214, each of which is attachable to the reservoir 212. Several embodiments of the lid 214 are illustrated in FIGS. 7A-7C. For example, FIG. 7A illustrates a spouted lid 214; FIG. 7B illustrates a straw lid 214; and FIG. 7C illustrates an open lid 214. The spouted lid 214 of FIG. 7A may include a generally cylindrical base 216 and a drink opening 218 connected by a conical portion 220. The drink opening 218 may be slot-shaped, as illustrated in FIG. 7A, or the drink opening 218 may be more circular or oval in shape. The spouted lid 214 is particularly useful with infants and toddlers that can grasp a cup, but that are prone to spilling. The straw lid 214 of FIG. 7B may include a generally cylindrical base 216 and a dome-shaped top 224. A straw 226 extends from the dome-shaped top 224. The straw 226 is fluidly connected to the reservoir to deliver fluid from the reservoir 212 to a drink opening 228. The straw 226 may be pivotably connected to the dome-shaped top 224 and may be pivotable to be stored in a recess 230 in the dome-shaped top 224 to prevent spills during transportation or movement of the cup 210. The open lid 214 illustrated in FIG. 7C may include a generally cylindrical base 216 and a relatively large drink opening 240. The lids 214 are interchangeable with one another so that different combinations of cups 210 and lids may be used. Various components of the cups 210 and lids 214 may be formed of similar or different materials. For example, in one embodiment, the various components may be formed from PLA corn-based resin, but the portion drinking cup 210 could also be formed from child-safe copolyester, such as EASTMAN TRITAN EX401, stainless steel, or other child-safe alternative.

The reservoir 212 may be of any shape that is suitable for holding liquid. For example, the reservoir may take the form of an hour-glass shape as shown in FIGS. 6A-6C. One skilled in the art will appreciate that other shapes for the reservoir 212 may be used which are suitable for grasping and handling by children. Furthermore, the reservoir should be sized such that it can contain a volume of liquid that is suitable for drinking by children in accordance to accepted children's nutrition guidelines.

As further shown in FIGS. 6A-6C, the reservoir 212 includes one or more liquid measuring components 250. The reservoir 212 may also include one or more liquid identifier components 252. The one or more liquid identifier components 252 may be provided on a surface of the reservoir 212 and form an indicator as to the type of liquid to be provided in the reservoir 212, as each reservoir 212 is also provided with one or more liquid measuring components 250 particularly associated with that identified liquid.

In one embodiment, as shown in FIGS. 6A and 6B, if the liquid to be served in the reservoir is milk or water, the reservoir 212 may include one liquid measuring component 250. The liquid measuring component 250 is an identifier that can also be provided on or in a surface of the reservoir 212. The liquid measuring component 250 corresponds to a properly determined portion of the particular liquid for a child of a particular age. In one example, the liquid measuring component 250 may include a line identifier provided around the circumference of the reservoir and an amount identifier provided on or in the surface of the reservoir 212 identifying, in this instance, that the proper liquid serving size for the particular liquid (e.g., 4 oz. milk, 4 oz. juice, or 8 oz. water, respectively).

In another embodiment, as illustrated in FIG. 6C, if the liquid to be served is directed to a juice serving, the reservoir 212 may include at least two liquid measuring components 250. A first liquid measuring component 250 is a first line identifier corresponding to the recommended portion of juice to be provided in a single serving according to dietary guidelines to a child of a particular age. A second liquid measuring component 250 is a second line identifier corresponding to an amount of a second liquid (in this case water), which can be added to the juice already provided in the reservoir to form a recommended serving for a child of a particular age. Accordingly, in this embodiment the liquid measuring components 250 depict the recommended-portion of juice-to-water ratio for the indication of dietary guidelines for one serving of fruits or vegetable in the form of juice.

As a specific example, a parent or caregiver may pour orange juice into the reservoir 212 up to a marked line depicting “juice” for a ½ cup (4 oz.) portion of juice, and then continue by pouring ½ cup (4 oz.) of water into the reservoir up to a marked line depicting “water,” for a total of 8 oz of child's beverage. In this way the reservoir 212 allows the parent to serve one portion of fruit or vegetable in the form of juice, without jeopardizing proper hydration or excessive sugar intake.

A top end of the reservoir 212 serves as an exit point for liquid. An outer surface from the top end of the reservoir may include a fastening structure. The fastening structure allows a lid 214 to attach or connect to the reservoir 212. In other examples, the fastening structure may be an angular groove, an angular ring or a snap fit. In another embodiment, the fastening structure may be a spiral or thread. The threading allows the lid 214 to be threadably attached to the reservoir 212. Although not necessary, having a lid be detachable from the reservoir 212 allows a user to better access the interior of the reservoir 212 for cleaning and filling.

To assemble the cup 210 the lid 214 is attached, e.g., by screwing, onto the reservoir 212. As the user rotates the lid 214, thread tabs travel along the arcuate section of the passage wall. Finally the lid 214 has a complete physical seal with the reservoir 212 when an edge of the lid 214 is fully engaged with a groove at the top end of the reservoir 212.

In yet other embodiments, audible markers can be incorporated to signal the user that the lid 214 has been locked: e.g., when the lid 214 is rotated onto the groove at the top end of the reservoir 212 a “click” can be heard when the lid 214 locks into position. Furthermore, to prevent spills from the reservoir, a gasket (not shown) may be incorporated in the spouted lid 214 or straw lid 214.

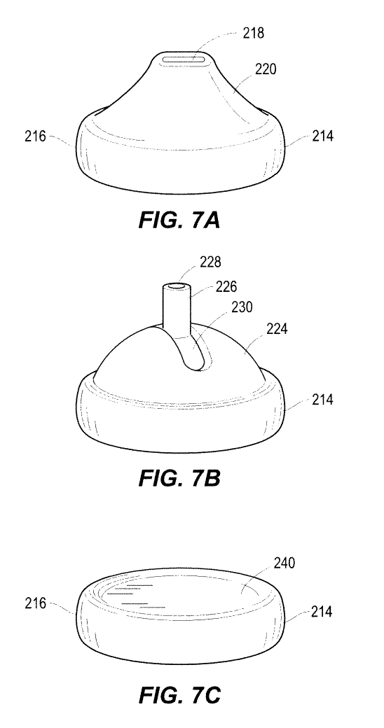

Referring to FIG. 8 depicts one embodiment of an eating utensil 300, which is particularly designed for use by small children or other individuals having limited capacity. However, one skilled in the art will appreciate such a utensil may alternatively be configured for use by older children, adults and the like. As shown in FIG. 8, the eating utensil 300 comprises a fork portion 310, a spoon portion 320, and a knife portion 330. The eating utensil 300 includes a body 340 defining a handle portion 342 shaped to permit grasping by the user as well as a non-sharp curved edge with a bevel 344 for cutting or spreading. This bevel 344 corresponds to the knife portion 330 of the utensil 300. In one embodiment, the body 340 connects with a base connecting portion 346. In this embodiment, the base connection portion 346 further connects with a food well 348.

The food well 348 extends from the base portion 346 of the body 340 and is capable of being used to scoop up and retain food. Cut into the rounded, oval shape of the well 348 is a series of reversed triangles 350, each rounded off for safety and capable of providing the function of a fork. However, one skilled in the art will appreciate this portion of the utensil may assume a series of other shapes in place of reversed triangles 350, such as squares or circles and may or may not include rounded tips.

The utensil 300 is formed as a single unit and, in one embodiment, is comprised of the same materials. For example, in one embodiment, a material is a non-toxic, child-safe plastic such as PLA corn-based resin, but the utensil could also be constructed of child-safe copolyester, such as EASTMAN TRITAN EX401, stainless steel or other child-safe alternative.

The utensil may be of any shape that is suitable for holding, spearing, spreading, or cutting food. For example, the food well 348 may be triangular or the body 340 or handle 342 maybe animalistic in shape. One skilled in the art may pick a shape that that is suitable for grasping and handling by children. Furthermore, the food well 348 should be able to contain a volume suitable for eating by children.

The spoon portion 320 has a food-retaining portion 352, which comprises a relatively thin portion defining a concave portion similar to that of a conventional spoon.

The fork portion 310 has a food-retaining portion 354 comprised of series of reversed triangles that create tines 356. Each tine 356 has a rounded shape that reduces the possibility that a tine will contact a user's mouth in a manner causing injury. However, other rounded, blunt, or arcuate shapes having a smooth contour to prevent injury could also be utilized if desired for a particular application. Outer edges of the tines 356 are tangential with the outer edge of food well 348 thereby providing a smoothly curved transition from side to side.

The knife portion 330 serves a multi-function both as a handle, the curvature of which is comfortable for small hands to grasp, and a knife. A non-sharp, beveled edge 344 extends along the side serves as a rounded, blunt knife, which is similar to that of a conventional knife.

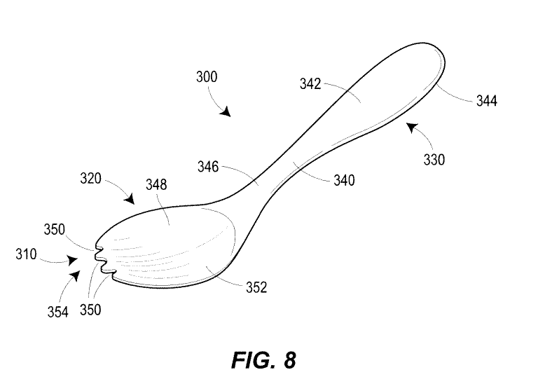

One embodiment of a dicer 400 is illustrated in FIG. 9. The dicer 400 includes a base portion 410 having a storage portion 412 and a cutting grid 414. The dicer 400 also may include a top portion 416 that is connected at one end to a corresponding end of the base portion 410. The top portion 416 can function as a lid to the base portion 410, and also as a means for providing pressure to food positioned on the cutting grid 414 of the base portion 410. When a user lowers the top portion 416 to put pressure on food positioned between the top and base portions 416, 410 on the cutting grid 414, the food is thereby forced through the cutting grid 414 resulting in creation of small bite-size food pieces designed specifically for consumption by a child of a particular age. Different shape bite-size food pieces may be chosen by substituting one or more interchangeable cutting grids 414 that have different shaped openings.

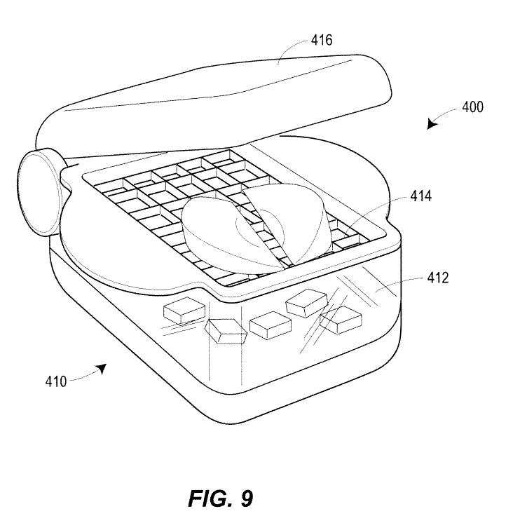

One embodiment of a meal planning kit 600 is illustrated in FIG. 10. The kit 600 may include a container 602 having a lid 604. A plurality of meal planning plates 10, a plurality of portion drinking cups 210, and at least one eating utensil 300 may be included in the kit 600. Optionally a plurality of measuring scoops (not shown) may also be included in the kit 600. The kit 600 provides a complete meal mapping capability for a user. By adhering to the meal map outlined by the products in the kit 600, a user can be assured that he or she is receiving at least the recommended minimum daily nutritional requirements.

A method of manufacturing a set of food preparation or serving devices comprises providing a first meal planning device and dividing the first meal planning device into a first plurality of locations, each location corresponding to a different food group. At least one location in the first plurality of locations is marked with one of a first picture, a first text, or a first color that indicates a color of food to be placed in the at least one location in the first plurality of locations. A second a second meal planning device is provided and divided into a second plurality of locations, each location corresponding to a different food group. At least one location in the second plurality of locations is marked with one of a second picture, a second text, and a second color that indicates a color of food to be placed in the at least one location in the second plurality of locations. A third meal planning device is provided and divided into a third plurality of locations, each location corresponding to a different food group. At least one location in the third plurality of locations is marked with one of a third picture, a third text, and a third color that indicates a color of food to be placed in the at least one location in the third plurality of locations. One of the first color, the second color, and the third color is different from at least one of the others of the first color, the second color, and the third color.

Numerous modifications and alternative embodiments of the invention will be apparent to those skilled in the art in view of the forgoing description. Accordingly, this description is to be construed as illustrative only and is for the purpose of teaching those skilled in the art the best mode of carrying out the invention. The details of the present disclosure may be varied without departing from the spirit of the invention, and the exclusive use of all modifications which are within the scope of the claims is reserved.

1. A daily meal planning system comprising:
a meal planning device including at least one of;
at least one segregated area, the at least one segregated area having a plurality of interchangeable indicia, each indicia indicating a food group to be placed on the at least one segregated area; and
at least one food well, the at least one food well including indicia that indicate a food group to be placed within the at least one food well,
wherein the at least one segregated area and the at least one food well each map a nutritionally sufficient amount of a particular food group to meet dietary guidelines for a user for a given meal.

2. The device of claim 1, wherein the meal planning device is a first meal planning plate having a first top surface; and
a first plurality of food wells are formed in the first top surface, each food well in the first plurality of food wells forming a volume between a bottom of the food well and an intersection of the food well and the first top surface, at least two food wells in the first plurality of food wells having different volumes.

3. The device of claim 2, further comprising a second meal planning device wherein the second meal planning device is a second meal planning plate having a second top surface; and
a second plurality of food wells that are formed in the second top surface, each food well in the second plurality of food wells forming a volume between a bottom of the food well and an intersection of the food well and the second top surface, at least two food wells in the second plurality of food wells having different volumes.

4. The device of claim 3, further comprising a third meal planning device wherein the third meal planning device is a third meal planning plate having a third top surface; and
a third plurality of food wells that are formed in the third top surface, each food well in the third plurality of food wells forming a volume between a bottom of the food well and an intersection of the food well and the third top surface, at least two food wells in the third plurality of food wells having different volumes.

5. The device of claim 4, wherein the at least one food well in the first plurality of food wells has a volume that is approximately equal to a nutritionally sufficient volume of food from one food group for a user, at least one food well in the second plurality of food wells has a volume that is approximately equal to a nutritionally sufficient volume of food from one food group for the user, and at least one food well in the third plurality of food wells has a volume that is approximately equal to a nutritionally sufficient volume of food from one food group for the user, when used together, the first meal planning device, the second meal planning device, and the third meal planning device define a nutritionally sufficient daily meal plan for the user.

6. The device of claim 4, wherein at least one food well in the first plurality of food wells may include a first indicim representing a first food group and a first color of food to be placed within the at least one food well, and at least one food well in the second plurality of food wells may include a second indicum representing a second food group and a second color of food to be placed within the at least one food well in the second plurality of food wells, the first and second colors being different and the first and second food groups being the same.

7. The device of claim 1, further comprising a see-through window in the segregated area.

8. The device of claim 7, further comprising a plurality of food group cards, each food group card being insertable into a slot in the meal planning device and viewable through the window.

9. The device of claim 1, further comprising a first raised rim at least partially surrounding the food well.

10. The device of claim 9, wherein the first raised rim has a first color that is the same as a color of food indicated by a first indicium located in the first food well.

11. The device of claim 10, further comprising a second raised rim at least partially surrounding a second food well.

12. The device of claim 11, wherein the second raised rim has a second color that is the same as a color of food indicated by a second indicium located in the second food well.

13. The device of claim 12, wherein the first color is different from the second color.

14. The device of claim 1, further comprising a perimeter rim extending around a perimeter of the device.

15. A set of measuring scoops, the set of measuring scoops being sized to provide nutritionally sufficient volumes of given food groups for one or more nutritious meals per day for a user, the set of measuring scoops comprising:
a first scoop including a first food well having a concave shaped first bottom surface, the first food well being connected to a first handle portion by a first base portion;
a second scoop including a second food well having a concave shaped second bottom surface, the second food well being connected to a second handle portion by a second base portion; and
a third scoop including a third food well having a concave shaped third bottom surface, the third food well being connected to a third handle portion by a third base portion,
wherein volumes of the first food well, the second food well, and the third food well are based upon a user to measure nutritionally sufficient volumes of food for the user for different food groups, when used together, the first scoop, the second scoop, and the third scoop measure nutritionally sufficient food volumes of different food groups, the nutritionally sufficient food volumes forming a well-balanced and nutritionally sufficient meal.

16. The set of scoops of claim 15, wherein the first handle portion includes a recessed area.

17. The set of scoops of claim 16, wherein the recessed area includes an opening.

18. The set of scoops of claim 17, further comprising a ring sized to be disposed in the opening to temporarily connect the first scoop, the second scoop, and the third scoop together.

19. The set of scoops of claim 15, the first handle portion including a first indicium indicative of a first food group.

20. The set of scoops of claim 19, wherein the first handle portion may include a first picture indicative of the first food group.

21. A set of portion drinking cups, the set of portion drinking cups being sized to provide nutritionally sufficient volumes of given liquids for a user, the set of portion drinking cups comprising:
a first portion drinking cup having a first reservoir for holding a first liquid, the first reservoir having a first opening, and a first lid for covering the first opening, the first portion drinking cup having a first liquid measuring component indicative of a volume of the first liquid approximately equal to a single serving of the first liquid for a user; and
a second portion drinking cup having a second reservoir for holding a second liquid, the second reservoir having a second opening, and a second lid for covering the second opening, the second measuring cup having a second liquid measuring component indicative of a volume of the second liquid approximately equal to a single serving of the second liquid for a user.

22. The set of portion drinking cups of claim 21, wherein the first portion drinking cup has a second lid that is interchangeable with the first lid, the first lid defining a straw and the second lid defining a spout.

23. The set of portion cups of claim 21, wherein the first portion cup may include a plurality of liquid measuring components.

24. A portion drinking cup, the portion drinking cup being sized to provide nutritionally sufficient volumes of given liquids for a user, the portion drinking cup comprising:
a reservoir for holding a liquid, the reservoir having an opening, and a lid for covering the opening,
a first liquid measuring component indicative of a volume of a first liquid approximately equal to a single serving of the first liquid for a user; and
a second liquid measuring component indicative of a volume of a second liquid approximately equal to a single serving of the second liquid for a user.

25. A meal planning kit for a user, the meal planning kit comprising at least one of:
a set of meal plates having;
a first plate having a first top surface;
a first plurality of food wells formed in the first top surface, each food well in the first plurality of food wells fowling a volume between a bottom of the food well and an intersection of the food well and the first top surface, at least two food wells in the first plurality of food wells having different volumes;
a second plate having a second top surface;
a second plurality of food wells formed in the second top surface, each food well in the second plurality of food wells forming a volume between a bottom of the food well and an intersection of the food well and the second top surface, at least two food wells in the second plurality of food wells having different volumes; and
a third plate having a third top surface;
a third plurality of food wells formed in the third top surface, each food well in the third plurality of food wells forming a volume between a bottom of the food well and an intersection of the food well and the third top surface, at least two food wells in the third plurality of food wells having different volumes;
a set of measuring scoops having;
a first scoop including a first food well having a concave shaped first bottom surface, the first food well being connected to a first handle portion by a first rubberized base portion;
a second scoop including a second food well having a concave shaped second bottom surface, the second food well being connected to a second handle portion by a second rubberized base portion; and
a third scoop including a third food well having a concave shaped third bottom surface, the third food well being connected to a third handle portion by a third rubberized base portion;
a set of portion drinking cups having;
a first portion drinking cup having a first reservoir for holding a first liquid, the first reservoir having a first opening, and a first lid for covering the first opening, the first portion drinking cup having a first liquid measuring component indicative of a volume of the first liquid equal to a single serving of the first liquid for a child of a given age; and
a second portion drinking cup having a second reservoir for holding a second liquid, the second reservoir having a second opening, and a second lid for covering the second opening, the second measuring cup having a second liquid measuring component indicative of a volume of the second liquid equal to a single serving of the second liquid for a child of a given age; and
a plurality of eating utensils, each eating utensil having;
a fork portion;
a spoon portion; and
a knife portion,
the fork portion, spoon portion, and knife portion each being attached to a body of the eating utensil.

26. A set of meal planning devices, the set of meal planning devices providing a daily nutritional map for a user, the set of meal planning devices comprising:
a first meal planning device having a first top surface;
a first plurality of segregated areas formed on the first top surface, each segregated area in the first plurality of segregated areas forming an area on the first top surface, at least two segregated areas in the first plurality of segregated areas having different areas;
a second meal planning device having a second top surface;
a second plurality of segregated areas formed on the second top surface, each segregated area in the second plurality of segregated areas forming an area on the second top surface, at least two segregated areas in the second plurality of segregated areas having different areas;
a third meal planning device having a third top surface;
a third plurality of segregated areas formed on the third top surface, each segregated area in the third plurality of segregated areas forming an area on the third top surface, at least two segregated areas in the third plurality of segregated areas having different areas,
wherein the first meal planning device is a breakfast meal planning device and at least one segregated area in the first plurality of segregated areas has an area that is equal to a nutritionally sufficient area of food from one food group for a user, the second meal planning device is a lunch meal planning device and at least one segregated area in the second plurality of segregated areas has an area that is approximately equal to a nutritionally sufficient area of food from one food group for a user, and the third meal planning device is a dinner meal planning device and at least one segregated area in the third plurality of segregated areas has an area that is approximately equal to a nutritionally sufficient area of food from one food group for a user, when used together, the first meal planning device, the second meal planning device, and the third meal planning device define a nutritionally sufficient daily meal plan for a user.
